(19) United States
(12) Patent Application Publication
(10) Pub. No.: US 2014/0026089 A1
(43) Pub. Date: Jan. 23, 2014

(54) ASSET MANAGEMENT SYSTEM AND METHOD

(71) Applicant: GENERAL ELECTRIC COMPANY, Schenectady, NY (US)

(72) Inventors: Neil Linton, Atlanta, GA (US); Tim Masters, Marietta, GA (US)

(21) Appl. No.: 13/941,875

(22) Filed: Jul. 15, 2013

Related U.S. Application Data
(60) Provisional application No. 61/672,354, filed on Jul. 17, 2012.

(51) Int. Cl. G06F 3/0484

(52) U.S. Cl. CPC G06F 3/04842
USPC 715/765

(57) ABSTRACT

Systems and methods for providing a graphical interface and application for managing assets in an asset zone such as a yard, a port, a warehouse, or a lot. Embodiments of the invention provide an asset management software application configured to manage assets pro-actively by maximizing visibility of the asset zone and by providing selectable options to a user to improve operations across the asset zone.

This U.S. patent application claims priority to pending provisional U.S. patent application Ser. No. 61/672,354 filed on Jul. 17, 2012 which is incorporated herein by reference in its entirety.

### BACKGROUND

1. Technical Field

The subject matter disclosed herein relates to methods and systems providing a graphical interface for managing assets in an asset zone such as a yard, a port, a warehouse, or a lot.

2. Discussion of Art

A railroad yard, a shipping port, a warehouse, or a rental car parking lot may have assets (e.g., rail cars, ships, products, automobiles) located throughout which are to be managed in various ways (e.g., moved, loaded, stacked, linked, assigned, rented). Keeping track of the assets and the status of the assets in an asset zone can be very challenging. It may be desirable to have a system that helps a user manage assets in an asset zone better than those systems and methods that are currently available.

### BRIEF DESCRIPTION

Systems and methods for providing a graphical interface and application for managing assets in an asset zone such as a yard, a port, a warehouse, or a lot are disclosed. Embodiments of the invention provide an asset management software application configured to manage assets pro-actively by maximizing visibility of the asset zone and by providing selectable options to a user to improve operations across the asset zone.

In one embodiment, a system is provided. The system includes a controller to provide, on a user interface, selectable options to a user for managing assets and activities within an asset zone and to control generation of a representation on the user interface of: the asset zone, assets associable with the asset zone, and one or more characteristics of the assets.

In one embodiment, a computerized method is provided. The method includes obtaining transportation information associated with assets associated with an asset zone. Based at least in part on the transportation information that is obtained, the displaying of representations of the assets located within the asset zone along with characteristics of the assets are controlled. Selectable options are provided to a user for reviewing and editing the transportation information.

In one embodiment, a system is provided. The system includes a controller. The controller is operable to control display of, on a display screen, a representation of an asset zone and representations of assets located within the asset zone. The controller is operable to control, based on user input, modification of the representation of the asset zone that is displayed on the display screen, modification of characteristics of the representations of the assets that are displayed on the display screen, and movement of the representations of the assets that are displayed on the display screen.

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system to visually and graphically manage assets and activities within an asset zone;

FIG. 2 illustrates a first exemplary embodiment of a screen shot of a map view of an asset zone provided by the system of FIG. 1;

FIG. 3 illustrates a second exemplary embodiment of a screen shot of a map view (an aerial map view) of an asset zone provided by the system of FIG. 1;

FIG. 4 illustrates an exemplary embodiment of a screen shot of a yard view of an asset zone provided by the system of FIG. 1;

FIG. 5 illustrates an exemplary embodiment of a screen shot of a list view of an asset zone provided by the system of FIG. 1;

FIG. 6 illustrates an exemplary embodiment of a screen shot showing how to sort and filter using the list view of FIG. 5;

FIG. 7 illustrates an exemplary embodiment of a screen shot showing the color coding of assets in the map view of FIG. 2;

FIG. 8 illustrates an exemplary embodiment of a screen shot showing the color coding of assets in the yard view of FIG. 4; and

FIG. 9 illustrates an exemplary embodiment of a screen shot showing the color coding of assets in the list view of FIG. 5.

### DETAILED DESCRIPTION

Embodiments of the invention relate to methods and systems providing a graphical interface for managing assets in an asset zone such as a yard, a port, a warehouse, or a lot. For example, a rail yard may have many tracks for storing and organizing rail car and locomotive assets. A rail yard may be located along a main rail line to temporarily store cars and to build trains of cars for transport. The assets may pass through the rail yard from a main line while in transit from a shipper to a receiver, for example. The rail cars may be moved within the rail yard by switcher locomotives working in the rail yard to sort the cars. Rail cars may be sorted according to whether the cars are loaded with product or not, car type, destination, car owner or railroad company, or whether or not maintenance is to be performed on the cars in the rail yard.

The terms “container” and “trailer” refer to a storage medium configured to hold products, goods, or other shippable materials. The term “asset zone” refers to a location, site, area, or facility where assets are managed. The managing of assets may include, for example, moving, loading, stacking, linking, assigning, renting, and shipping the assets. The term “asset” refers generally to anything that may be managed in an asset zone. Examples of assets include, but are not limited to, rail cars in a rail yard, containers/trailers in a rail yard, products in a warehouse, ships in a shipping port, mining equipment at a mining site, and rental cars in a rental car lot.

The term “product” or “commodity” as used herein refers to any materials or manufactured goods that may be transported. The term “shipper” refers to an entity in the business of shipping products via some form of transportation (e.g., via rail cars on a railroad). A shipper may or may not also be in the business of producing, mining, or processing the product (e.g., coal) to be shipped. The term “receiver” refers to an entity in the business of receiving products from shippers via some form of transportation (e.g., via tractor trailers). A receiver may or may not also be in the business of using or further processing the product (e.g., plastic pellets).

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or program involved in managing assets associated with an asset zone. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. The term “virtual” as used herein refers to the simulation of real world objects and characteristics in a computer environment. The terms “configure”, “stack”, and “build” may be used interchangeably herein when referring to virtually or actually creating a profile of containers/trailers on cars or vessels of a train, or when linking assets together to form a consist or block.

The system and methods described herein may be discussed in the context of a rail yard or terminal of a railroad as being the asset zone with rail cars and/or containers/trailers as the assets. However, embodiments of the invention may apply equally well to other asset zones such as, for example, a shipping port, a warehouse, or a rental car parking lot, along with their corresponding assets.

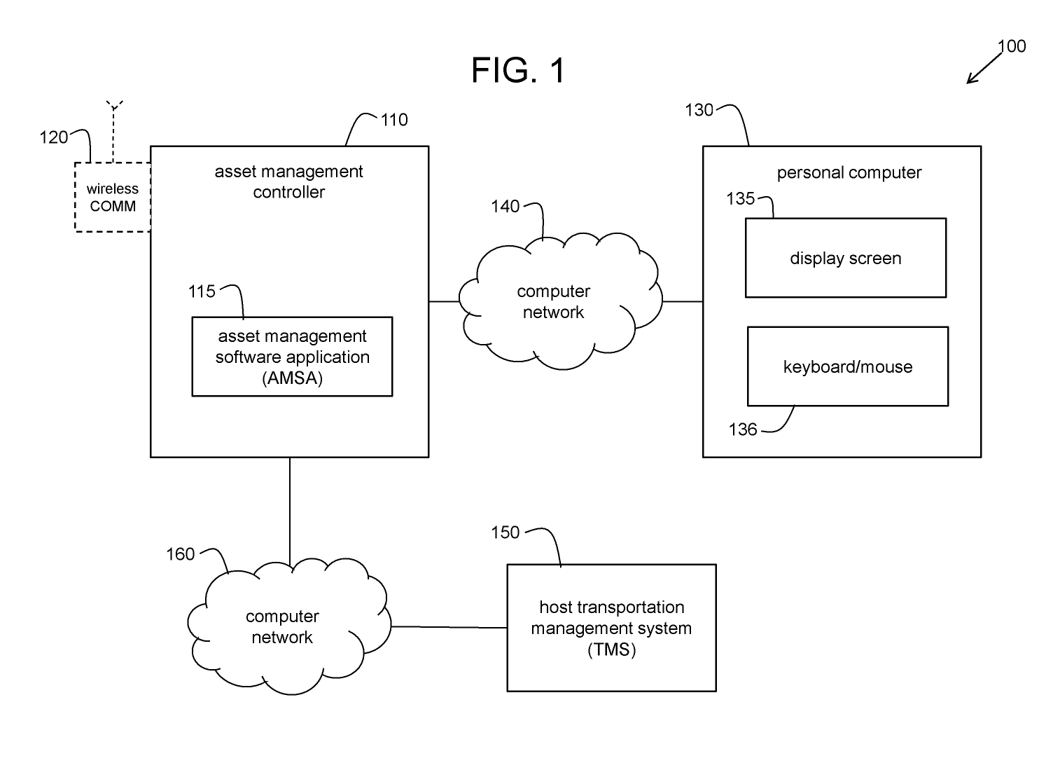

FIG. 1 is a schematic block diagram of an exemplary embodiment of a system 100 to visually and graphically manage assets and activities within an asset zone. The asset zone may be, for example, a railroad intermodal terminal or yard, a product warehouse, a rental car parking lot, a mining site, or any location and/or facility where assets are managed (e.g., moved, loaded, stacked, linked, assigned, rented). Therefore, the managed activities may include, for example, assigning an asset to a destination, moving an asset within the asset zone, stacking an asset onto another asset, linking an asset to another asset, or checking a status of an asset.

The system 100 includes an asset management controller 110 operable to manage assets, transactions, and activities taking place within an asset zone, and operable to facilitate the virtual representation of an asset zone, assets associable with the asset zone, and characteristics of the assets. Selectable options may be provided to a user for managing the assets within the asset zone through a graphical user interface. Integrated inbound and outbound asset visibility is provided, along with automation of key tasks and work orders for crews in the asset zone. In accordance with an embodiment, the asset management controller 110 is implemented as a server computer 110 running an asset management software application (AMSA) 115. The controller 110 may include one or more processing elements (e.g., microprocessors) for executing the software application 115. The asset management controller 110 manages assets within the asset zone (e.g., the assignment, loading, and movement of assets within the asset zone) and provides a graphical mapping that allows visualization of the asset zone by a user on a display screen.

As an option, the system 100 may include a wireless communication (COMM) device 120 operably interfacing to the server computer 110 and configured to communicate with other wireless devices (e.g., via radio frequency communication) operating within the asset zone. Such other wireless devices may be hand-held devices used by inspectors, or may be located in cranes or other on-site transportation vehicles within the asset zone, and are configured to communicate with the asset management controller 110.

The system 100 also includes a user computer 130 (e.g., a personal computer, a hand-held tablet computer, or a mobile telephone) having a user interface including a display screen 135 (e.g., a touchscreen display) and, optionally, a keyboard, mouse, and/or other input device 136. The user computer also includes a processing element (not shown) and is configured to communicate with the asset management controller 110 directly and/or via a communication infrastructure 140 (e.g., a computer network 140). The user computer may be located in an office on site at the asset zone, or may be remotely located away from the asset zone. In accordance with an embodiment, the user computer may be a mobile, wireless, touch-screen, hand-held device that may be used by a user as the user walks or drives around the asset zone (e.g., if the user is part of a maintenance crew). In accordance with such a hand-held embodiment, the system 100 may provide a directional locator function, directing a user to an asset within the asset zone that is selected by the user.

The system 100 also includes a host transportation management system (TMS) 150 in operative communication with the asset management controller 110 via, for example, a communication infrastructure 160 (e.g., a computer network 160). The TMS 150 is configured to manage various aspects (e.g., scheduling, tracking, way billing, revenue accounting) of a larger transportation system such as, for example, an entire railroad. Therefore, the TMS 150 may communicate with a plurality of asset management controllers 110 at a plurality of railroad terminals (asset zones) of the railroad, for example.

In accordance with various other embodiments of the present invention, the system may be configured in various other ways. For example, if the asset management controller is on site at a railroad terminal, the user computer may communicate in a direct wired manner with the controller, or via a communication network 140 which may be a local area network. If the asset management controller is remotely located from the railroad terminal, then communication with the user computer may be via the internet. For example, the asset management controller may be co-located with or be implemented on a same server computer as the TMS 150. As another example, the asset management controller may be hosted at a third party site (e.g., a provider of the AMSA) as a software-as-a-service (SaaS) configuration. As a further example, the computer networks 140 and 160 may be the same network (e.g., the internet). Other configurations are possible as well, in accordance with various other embodiments of the present invention.

In the example where the asset zone is a rail yard and the assets are rail cars, locomotives, and other rail vehicles, the rail cars may be located throughout a rail yard, may be loaded or unloaded, and may or may not be linked to a train of rail cars to be moved by one or more of the locomotives. In accordance with an embodiment, the system provides a graphical interface that is displayed on a display screen 135 of the user computer allowing a user to manage assets in the rail yard (asset zone) as discussed below herein. (This embodiment is also applicable to other types of asset zones and assets). A user can interact with the asset management controller via the user computer to virtually view the location of cars on tracks within the rail yard, check the status of a rail car, update (move) the location of a rail car within the rail yard, and review and edit transportation (e.g., waybill) information for a car. Checking the status of a rail car may involve, for example, checking if a car is loaded and with what commodity, checking the identity of the customer of the loaded commodity, checking the assigned destination of the rail car, and checking the owner of the rail car. Waybill information for a rail car may be checked and edited using the system of FIG. 1.

In one embodiment, a computerized method is provided. The computerized method includes obtaining transportation information associated with assets located in (or otherwise associated with) an asset zone, processing the obtained transportation information to facilitate the virtual representation of the assets located within the asset zone along with characteristics of the assets, and providing selectable options to a user for reviewing and editing the transportation information. Further selectable options may include options for reviewing asset and asset zone information, options for editing asset and asset zone information, options for selecting assets, options for selecting views, options for sorting and filtering displayed information, and/or options for color coding displayed information.

The method may further include displaying the virtual representation as one or more of graphical icons and text information. The method may also include obtaining and displaying characteristics of the assets. The characteristics may include one or more of asset container type, asset identification, asset status (e.g., asset load/empty status), commodity type loaded on an asset, customer identity of a commodity loaded on an asset, weight information, way billing information, assigned destination of an asset, or asset ownership. The method may further include checking a status of an asset. Checking a status of an asset may include one or more of checking what type of commodity is loaded on an asset, checking an identity of a customer of a commodity loaded on an asset, checking an assigned destination of an asset, checking an origin of an asset, checking an owner of an asset, checking a current health of an asset, or checking a maintenance history of an asset. The transportation information may be obtained from a transportation management system and may include waybill information.

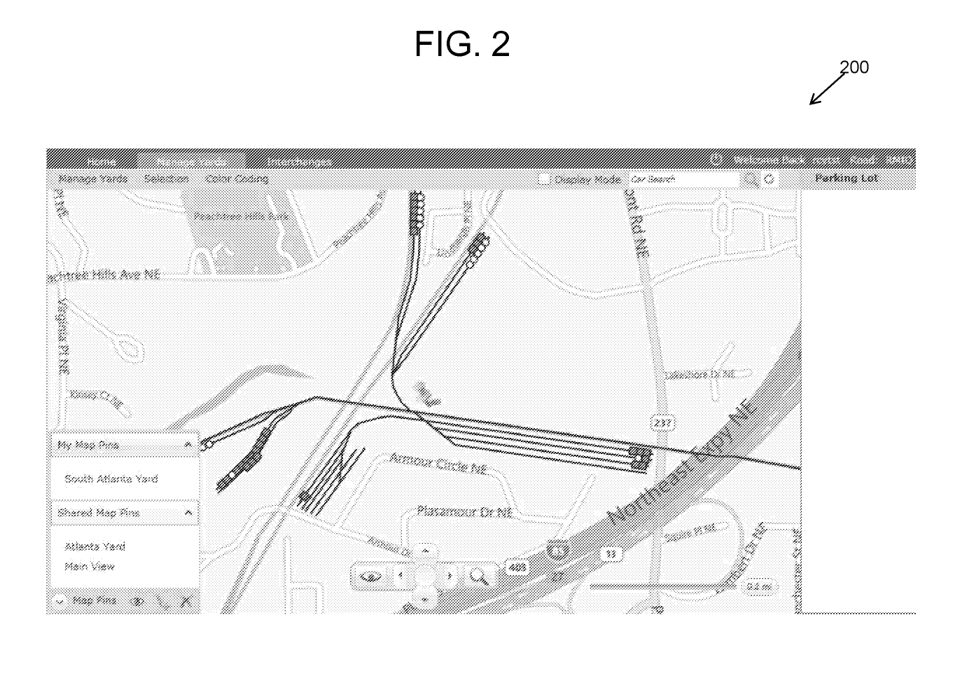

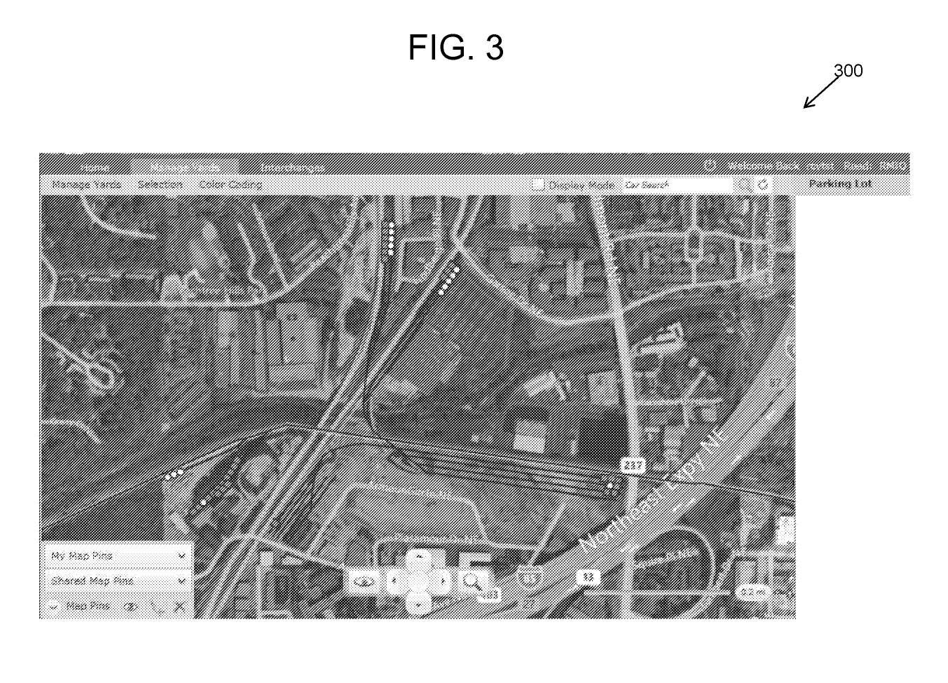

FIG. 2 illustrates a first exemplary embodiment of a screen shot of a map view 200 of an asset zone provided by the system of FIG. 1. FIG. 3 illustrates a second exemplary embodiment of a screen shot of a map view 300 (an aerial map view) of an asset zone provided by the system 100 of FIG. 1. The map view is a graphic representation of a rail yard and tracks laid over a map of the area. A user can select between a simple map (FIG. 2) or an aerial map (see FIG. 3). The simple map is the default map and is a simple street map. The aerial map is a satellite photo that shows the actual landscape. The aerial map may show actual rail cars that were present when the image was taken. However, those rail cars do not necessarily reflect the present inventory in the rail yard.

In accordance with an embodiment, a refresh icon is provided in the map view, allowing a user to update the view to show the current inventory (assets) in the yard as overlaid icons. Also, the inventory (and associated information) may be automatically updated, in accordance with an embodiment. The updated information is received by the controller from the TMS 150, in accordance with an embodiment, and processed by the AMSA 115 to refresh the view on the display screen 135 of the user computer. Rail car information may be presented in visual form as, for example, icons on a map overlay of the yard or zone. In accordance with an embodiment, the icons provide cues and clues about the status and location of a rail car, locomotive, or container/trailer which may include an asset identification (ID) code, a cargo type, a destination, an origination, a container type, asset health, equipment status, maintenance status, or load status.

A user can also mark locations in the map view using graphical representations of pins, and subsequently zoom in on a “pinned” location where the user desires to work. To add a new pin, a user may click on the “Add Pin” icon of the window and then click on the location to be pinned. In accordance with an embodiment, an “Add Pin” pop-up window will appear and the user may enter a name for the pin and specify whether the pin should be visible to only the user (my view) or to all users (shared view). A pin may also be designated as a default view such that, when a user goes to the map view, the view will open to that pin. In the map view, a user can switch between pin locations by either selecting a pin from a list in the window, or by clicking on the pin directly on the map (e.g., using a mouse).

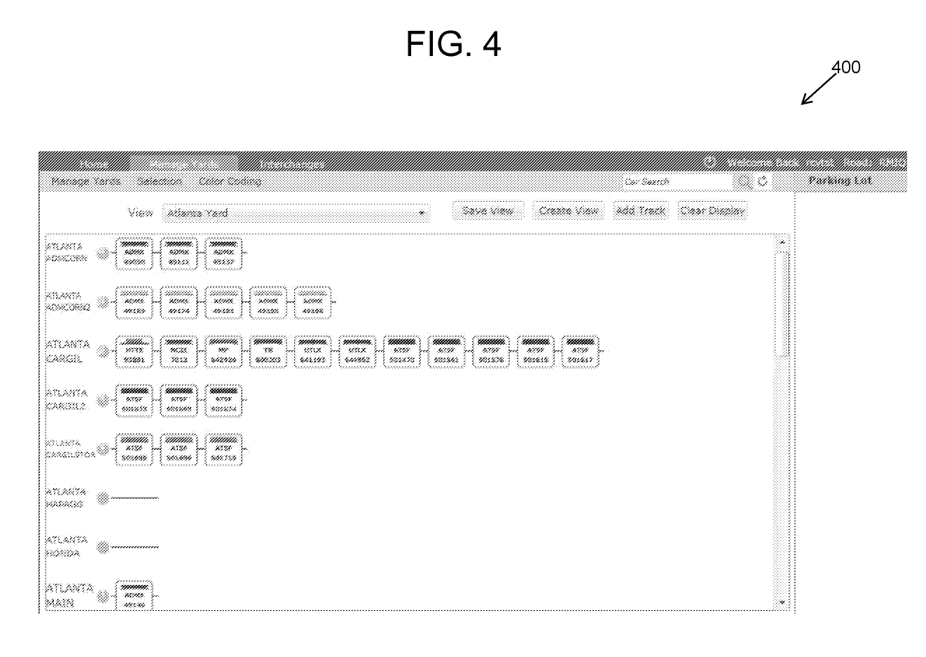

FIG. 4 illustrates an exemplary embodiment of a screen shot of a yard view 400 of an asset zone provided by the system of FIG. 1. The yard view in this embodiment is a graphic representation of a rail yard and rail tracks of an asset zone having rail cars on the rail tracks. Rail cars appear in an easy-to-read format along simple, linear tracks or strings in the yard view. Views may be created that contain the tracks that the user works with, or that the user works with most often, for example. This allows a user to more easily manage rail cars between tracks. The yard view is organized according to views that contain tracks specified by the user. A user may group tracks and stations together and switch between views by selecting from a “View” drop-down menu.

A user may edit a view by adding or removing tracks and clicking a “Save View” icon. For example, to create a new view, a user may click on a “Clear Display” icon to remove all tracks from the window in the yard view. The user may then click the “Add Tracks” icon to select the tracks that the user wants to view. The user may select from a list of stations that appear, and then click “Done”. All tracks from the selected stations will appear in the view. An individual track may be removed by right-clicking on the track name and selecting “Remove Track from this View”. When a user is satisfied with a view, the user may click the “Create View” icon. A “New View” pop-up window will appear which can be named by the user. Again, the user can specify for the new view to be visible only to the user (My View) or to all users (Shared View).

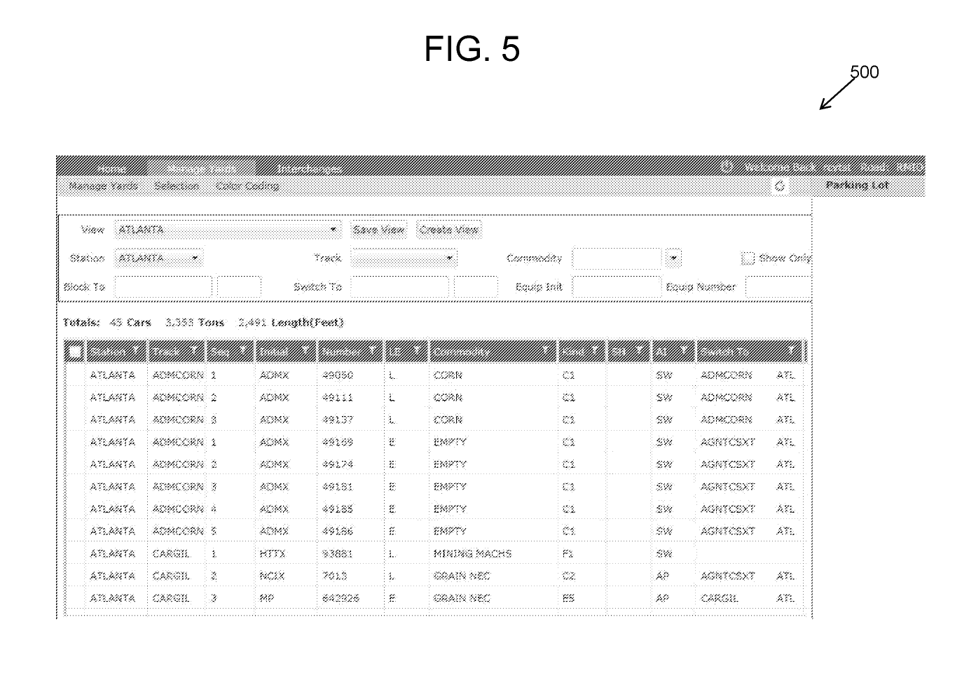

FIG. 5 illustrates an exemplary embodiment of a screen shot of a list view 500 of an asset zone provided by the system 100 of FIG. 1. The list view 500 is a textual representation of a yard and tracks, for example. Cars and tracks appear in a table format and views may be created that show the stations and/or tracks that a user desires. The list view is organized according to views that contain the station or track specified by the user and allows a user to quickly view the tracks the user works with most often, for example. A user may switch between views by selecting from the “View” drop-down menu. A user may create a new list view by selecting “Clear Selection” from the “View” drop-down menu to remove all tracks from the window, select the “Station” and/or “Track” the user wants to view, and click on the “Create View” icon. A “New View” pop-up window will appear and, again, a user can specify a name and visibility of the new view. A user may click the “Update” icon causing all cars from a selected station and/or track to appear in the view.

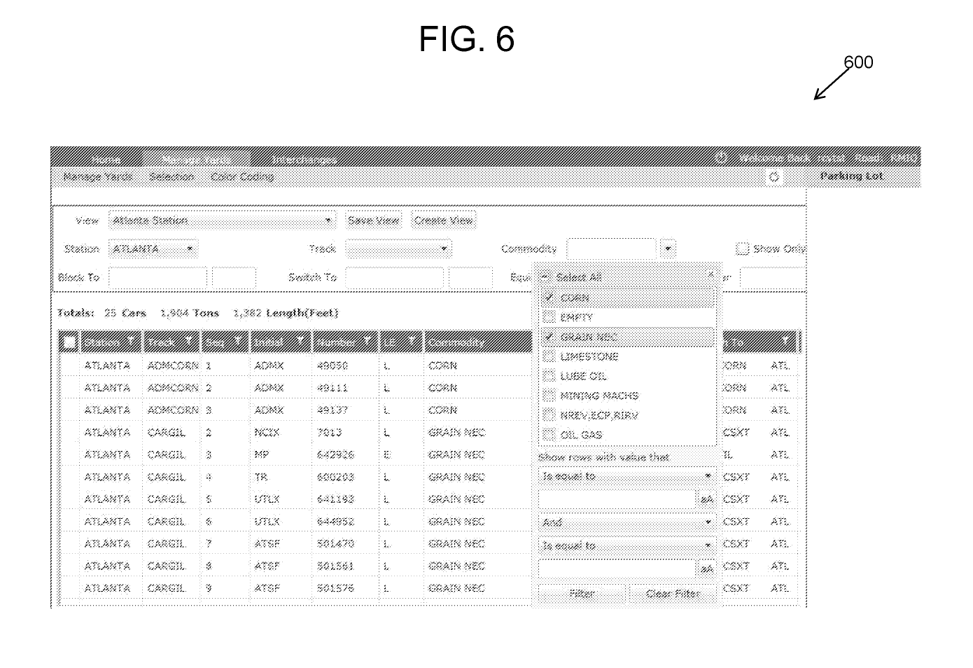

FIG. 6 illustrates an exemplary embodiment of a screen shot 600 showing how to sort and filter using the list view 500 of FIG. 5. In accordance with an embodiment, a user may sort the cars in the list view 500 by the values in any column. When a user clicks on a column header, the list is sorted according to the information in that column. If a user clicks the column header again, the sort will change between ascending and descending order.

A user may also filter the cars that appear in the list view using the values in any column. For example, if a user clicks on the filter icon (e.g., a funnel), a pop-up window appears and the user may select from the values appearing in the column or enter the values directly in the free-form fields. In addition to an “equal to” option, the free-form fields also provide a choice of filtering by values that do or do not begin with, end with, or contain a particular value. Once a user makes a selection, only cars that match the specified value(s) appear in the list.

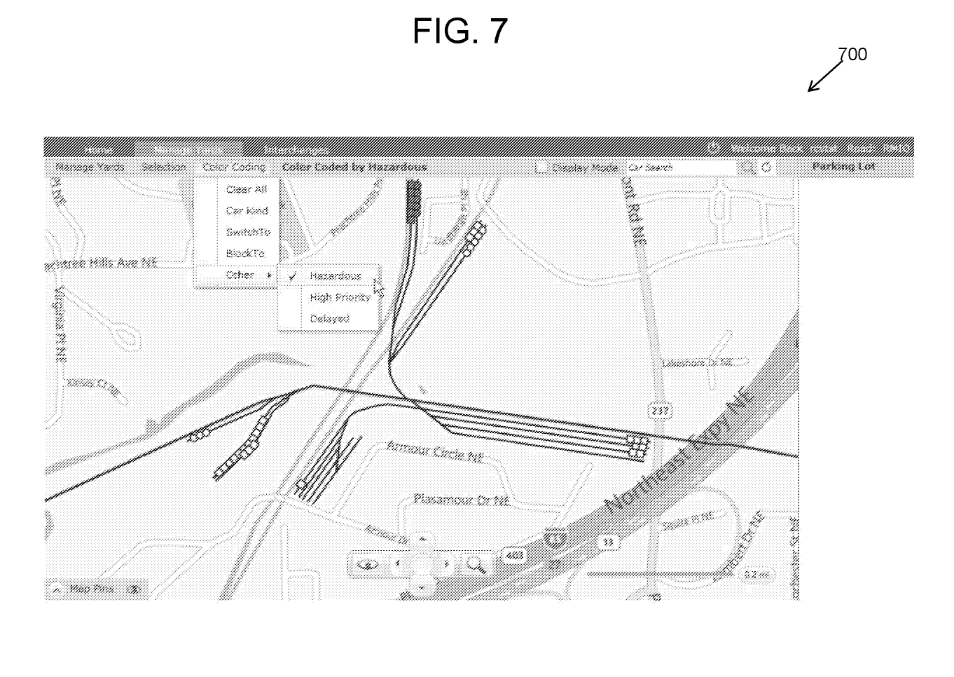

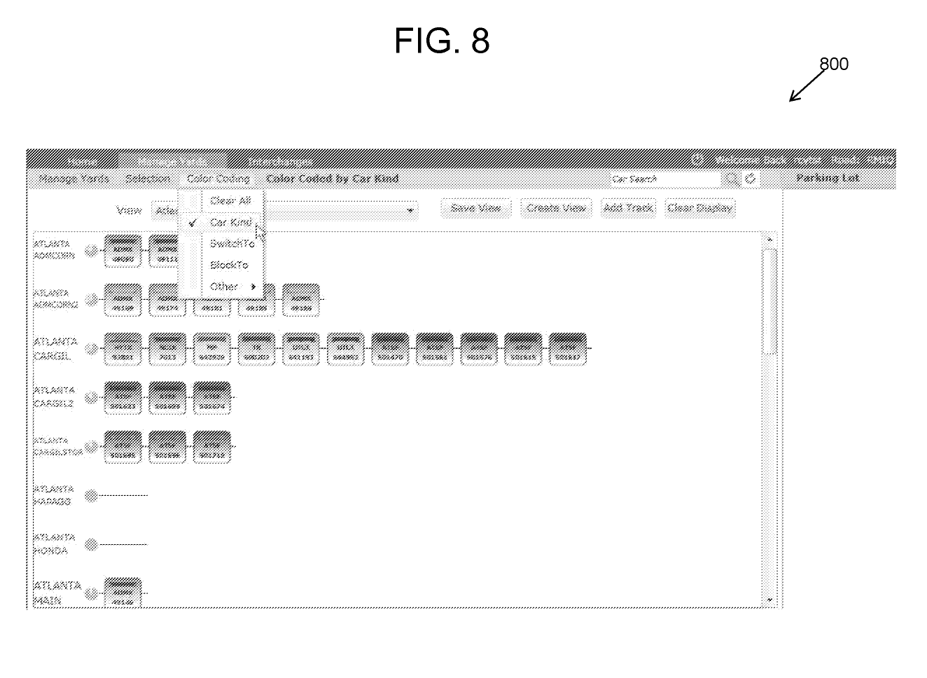

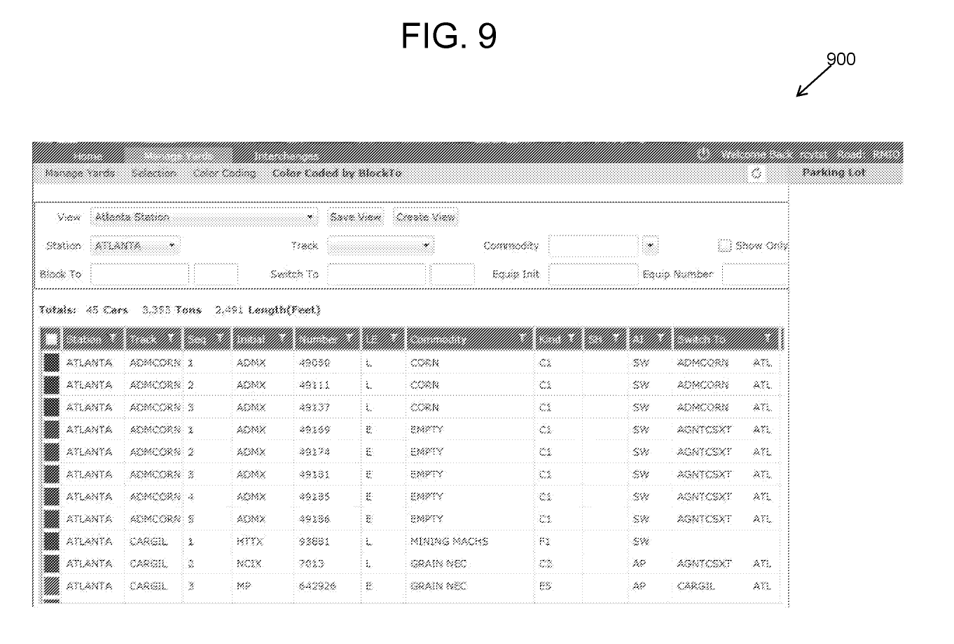

FIG. 7 illustrates an exemplary embodiment of a screen shot 700 showing the color coding of assets in the map view 200 of FIG. 2. Using a “Color Coding” option, a user may highlight cars on any view by the following designations: “Car Kind”, “Switch To”, “Block To”, or special handling (“Hazardous”, “High Priority”, or “Delayed”). As a result, a user may find particular groups of cars quickly by selecting a designation from a “Color Coding” drop-down menu, causing the corresponding cars to appear highlighted in the view. Similarly, FIG. 8 illustrates an exemplary embodiment of a screen shot 800 showing the color coding of assets in the yard view 400 of FIG. 4, and FIG. 9 illustrates an exemplary embodiment of a screen shot 900 showing the color coding of assets in the list view 500 of FIG. 5. FIGS. 7-9 herein illustrate the color coding in terms of shades of gray. However, in accordance with an embodiment, the color coding may be accomplished with other non-gray scale colors, providing better discernment to the user. Other types of asset coding are possible as well such as, for example, shape coding of asset icons, intensity coding of asset icons, and flashing coding of asset icons.

In accordance with an embodiment, a user may select cars in any view based on a variety of criteria including car type, load/empty status, switch to/block to value, or special handling options, allowing a user to choose groups of cars quickly and take action based on the criteria. In accordance with an embodiment, a parking lot area is provided in each view. The parking lot acts as a holding area when a user wants to work with groups of cars. To place a car (or multiple cars) in the parking lot area, a user may select a car(s) and drag and drop the car(s) to the parking lot area in the window. Moving a car to the parking lot area does not make any changes to the car in the system. However, once a group of cars are placed in the parking lot area, a user can readily select the entire group and edit the corresponding waybill information, or move the group of cars together within the yard. This is a useful option when a user wants to work with several cars that are currently on different tracks or when the user wants to add multiple cars to a consist (group of linked vehicles), for example.

In accordance with an embodiment, a user can select a “Display Mode” check box to make the parking lot area disappear from the displayed window in the map view. This provides the user with more room to work in the view. Furthermore, when in the “Display Mode”, the system updates automatically to provide the most up-to-date information to the user. In accordance with an embodiment, a user may draw and edit tracks such that the map view will match the setup of the yard operation. Tracks that are drawn may correspond to the tracks that are already defined in the TMS. However, a user may also draw a track that is not associated with a TMS track (usually representing connecting or wye tracks that do not hold cars).

In accordance with an embodiment, the controller and the user computer are operable to facilitate the modification of a virtual representation of an asset zone displayed on a display screen of the user computer, facilitate the modification of characteristics of virtual representations of assets located within the asset zone which are displayed on the display screen of the user computer, and facilitate the virtual movement of assets within the asset zone on the display screen of the user computer as commanded by a user. The virtual representations and movements may correspond to asset zones and assets, and the actual characteristics and movements of those assets in the real world. The modification of a virtual representation of an asset zone may include virtually adding or deleting tracks within the asset zone. The modification of characteristics of virtual representations of assets may include color coding the virtual assets. The modification of characteristics of virtual representations of assets may include assigning characteristics to the assets.

In accordance with an embodiment, the controller is operable to manage assets and activities within an asset zone. The user computer is configured to communicate with the controller. The user computer and the controller are operable to facilitate the displayed representation of assets in an asset zone and the status and location of assets within the asset zone, and provide a user with selectable options for managing the assets within the asset zone. The user computer may include a wireless, mobile, hand-held device configured to interact with the assets by reading an identifier device coupled to the assets. The user computer may include a stationary device configured to interact with the assets traveling proximate to the stationary device by reading an identifier device coupled to the assets. The displayed representation of the status and location of the assets may correspond to one or more of an asset identification code, a loaded commodity type, a destination of an asset, an origin of an asset, a container type, an asset health, an equipment status, a maintenance status of an asset, a load/empty status of an asset, an asset ownership, or geographic coordinates of an asset. The displayed representation of the assets may include one or more of graphical icons and text information.

Although trains are referred to herein, certain embodiments are more generally applicable to rail vehicle consists or other vehicle consists. A rail vehicle consist is a group of rail vehicles that are mechanically linked together to travel along a track. (A train is one example of a rail vehicle consist. Another example is a set of mining ore carts.) A vehicle consist, more generally, is a group of vehicles that are mechanically linked together to travel along a route. A powered vehicle consist refers to the interaction of two or more powered vehicles that are mechanically linked together, as may be the case for a locomotive consist (providing multiple powered vehicles to move a train of unpowered vehicles).

In accordance with an embodiment, the system may be used to record asset movement events within an asset zone. When an actual car is moved in an actual rail yard or terminal, a user of the system may update the system to reflect the move, for example, by dragging and dropping the icon corresponding to the car in a view displayed on the user computer. Cars may come online through an inbound interchange process. A user cannot move, place, release, load, or unload cars in the system until they are interchanged online. Cars stay online until a user moves them to another road through an outbound interchange. When a user moves a car (or a block of cars) to an online customer, the user places the car with the customer where demurrage rules set up in the system apply.

Simple track-to-track moves may be made within station limits. “Classifying” a track provides a way to rapidly move cars and create history records in a large flat switched or hump yard, for example. “Fanning” a track allows a user to move cars from one track to multiple other tracks within a station. “Resequencing” allows a user to change the order of cars on a track.

Station-to-station moves may be made either by “wheeling” cars or by using the TMS train functions. These moves may be recorded to “Car Movement History” and count for car hire mileage. Several move types move a car into and out of storage, may be recorded to movement history, and may be used to generate storage billing. Several move types are provided for recording when a car is defective and in need of repair. Cars may be marked as “bad order” and are flagged on various windows and reports throughout the system. When the car is repaired, the car may be moved off the “bad order” list. Each time a car is moved by a user, a record of the move is written to a car movement history file which can be accessed by a user.

In accordance with an embodiment, the controller and associated asset management software application 115 may include logic that provides a “sanity check” for the movement of cars in the system as initiated by a user. For example, there may be some car movements that are impossible, highly improbable, or unlikely to take place in a yard. If a user attempts to make such a movement of a car, the system 100 may disallow the move or at least provide an indication to the user that the move is highly unusual and suggest that the user may want to reconsider the move. Furthermore, movement of cars within the system made by a user may be verified, for example, against data collected within the actual yard corresponding to the actual movement of the cars (e.g., RFID data or OCR data). The actual movement of cars in the yard may also be time stamped, allowing the system to perform efficiency analysis of the movement of cars through the yard.

In accordance with an embodiment, the system allows a user to review and edit transportation information for any car. Basic transportation information (e.g., waybill information) for a car appears on the screen when a user, for example, hovers a cursor over that car on the display screen. The transportation information may be edited by right-clicking on the car and selecting “Edit Transportation Information”, for example. Data may then be edited and/or added via a pop-up window. In accordance with an embodiment, data fields include “Block To” which is a code showing the final destination of the car on the line, “Switch To” which corresponds to an intermediate destination of the car on the line, “AI” which is an activity code that may represent either a current status of the car or the activity to be performed next, “Product Group” which provides information about the product being transported. Other transportation data fields (e.g., switching instruction, station/track/spot, weigh, priority, and special handling) are possible as well, in accordance with various embodiments of the invention.

In accordance with an embodiment, the system allows a user to periodically review consists delivered to the railroad yard. When the user sees a new inbound consist listed, the user may check the cars on that consist and plan for interchanging and blocking cars as they are received. Cars of an inbound consist may be officially accepted by the user and moved into inventory in the railroad yard. Cars cannot be moved in the system until the user interchanges them online, however. After cars are accepted from a consist, the cars can be managed automatically or manually via the system. When a user is ready to deliver cars from the railroad yard, a user may transmit the outbound consists in advance of actual delivery, or transmit the outbound consists at the time of delivery. Once an outbound interchange is delivered, the cars may be removed from the inventory for the yard, and the cars may no longer be managed in that yard.

In one embodiment, the user computer has functionality to determine its own location, the current time, and to identify a nearby asset via, for example, near field RFID, barcode scanning, manual entry, OCR, or the like. This allows a user to update the system with an asset location at a particular time. The system can then compare the gathered information against an assumed location of the asset. Alternatively, using the location of the user computer and the assumed location of the asset, the system can guide a user to the asset.

The system may indicate certain paths or track sections that are occupied, or will be occupied, or are closed (e.g., for repair or an inoperative switch machine). The system can then calculate an optimal path from the current asset location to a user indicated new location. That path can be checked against the path or track sections that are unavailable, or may be unavailable during the time such a move of the asset is intended. In one aspect, the path of travel may be indicated on the user computer, and the path may be re-drawn by user input and/or by other rules or constraints applied by the user.

In one embodiment, a future arrival of a consist may be indicated as well as an estimated time of arrival of the consist. Thus, a system, in accordance with an embodiment, may indicate that there is an inbound train, calculate a breakdown of the incoming cars, and check if there are existing obstructions for the intended path of the incoming cars so that such obstructions (such as other parked assets) can be moved prior to the arrival of the consist.

In another embodiment, a system comprises a controller that is operable to provide, on a user interface, selectable options to a user for managing assets and activities within an asset zone, and that is operable to control generation of a representation on the user interface of: the asset zone, assets associable with the asset zone, and one or more characteristics of the assets.

In another embodiment of the system, the controller is operable to output control signals, based on the selectable options as selected by the user, for controlling movement of the assets within the asset zone and/or in to and out of the asset zone. For example, the control signals may comprise: signals communicated to the assets, which are used as a basis for controlling movement of the assets (e.g., automatic control, and/or human operator control); signals that are communicated elsewhere (than to the assets), which are used as a basis for controlling movement of the assets (e.g., signals communicated to vehicles or other machines that move the assets); signals used to generate schedules or plans according to which the assets are moved; signals that are communicated to wayside or other traffic control signals used to control movement of vehicles; and/or the like.

In another embodiment of the system, the representation on the user interface, which the controller is operable to control the generation of, comprises a map overlay showing at least one of a layout or a geography of the asset zone (layout referring to, for example, internal features of an asset zone, such as track and other infrastructure, and geography referring to, for example, information establishing a location of the asset zone within a larger region, e.g., a location of the asset zone in a city, state, country, etc.) The representation further comprises plural icons, displayed over the map overlay, respectively corresponding to positions of the assets in the asset zone. The one or more characteristics of the assets are displayed in respective association with the icons. (For example, the characteristics may be displayed as text, particular colors, shading, patterns, sizes, and/or shapes of the icons, as spatial relations (e.g., groupings) of the icons, or the like.) The selectable options comprise one or more user selectable common characteristics of the assets. That is, the controller is configured to receive a user input through the user interface, which selects a characteristic shared by two or more of the assets. Such characteristics may include loaded/empty status, carrying of hazardous cargo, carrying of other types of cargo, scheduled to depart within a designated time window, intermediate destination, final destination, destination direction, designated consist (e.g., into which the asset is to linked), and so on. The controller is operable to control display of the icons based in part on the selectable common characteristics, such that when the user selects one of the selectable common characteristics by way of the user interface, the controller is operable to control display of one or more of the icons, corresponding to one or more of the assets that exhibit said one of the selectable common characteristics that is selected by the user, to a common icon display format. That is, for all the displayed icons associated with assets sharing the selected common characteristic, the controller is operable to control the displayed icons to have at least one aspect in common (in regards to how the icons are displayed), which is representative of the selected common characteristic. For example, the icons may be displayed in the same color, the same shape, the same size, etc., which is different from other displayed icons that are not associated with assets having the selected common characteristic(s). In embodiments, the controller may be operable to allow for user selection of multiple common characteristics, and to display the icons as a function of the selected multiple common characteristics. For example, for a first selected common characteristic, the controller may be configured to control display of the icons so as to have a first common icon display format, and for a second selected common characteristic, the controller may be configured to control display of the icons so as to have a second common icon display format. (The common icon display format does not mean the icons are displayed necessarily exactly the same, although that is a possibility. Instead, it means the icons as displayed have at least one feature in common.) For example, if a user selects loaded status as the first selected common characteristic, and “scheduled for departure in one hour or less” as the second selected common characteristic, then all displayed icons associated with assets that are loaded may be controlled to have a first common icon display format (such as the same size or shape), and all displayed icons associated with assets that are scheduled for departure in one hour or less may be controlled to have a second common icon display format (such as the same color). For displayed icons that are associated with both selected common characteristics (in this example, loaded status and scheduled for departure in one hour or less), the icons would be displayed so as to have both the first common icon display format and the second icon display format (e.g., same color and same size or shape).

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A system, comprising a controller operable to provide, on a user interface, selectable options to a user for managing assets and activities within an asset zone and to control generation of a representation on the user interface of:
the asset zone,
assets associable with the asset zone, and
one or more characteristics of the assets.

2. The system of claim 1, wherein the one or more characteristics of the assets include one or more of asset container type, asset identification, asset commodity type, customer identity of an asset commodity, weight information, way billing information, asset assigned destination, asset ownership, or asset loaded/empty status.

3. The system of claim 1, wherein the selectable options include one or more of options for reviewing asset and asset zone information, options for editing the asset and asset zone information, options for selecting assets, options for selecting views, options for sorting and filtering displayed information, or options for color coding displayed information.

4. The system of claim 1, wherein the activities include one or more of assigning the assets to destinations, moving the assets within the asset zone, stacking the assets on one another, linking the assets to one another, or checking statuses of the assets.

5. The system of claim 1, wherein the controller is operable to output control signals, based on the selectable options as selected by the user, for controlling movement of the assets at least one of within the asset zone or in to and out of the asset zone.

6. The system of claim 1, wherein the representation on the user interface, which the controller is operable to control the generation of, comprises: a map overlay showing at least one of a layout or a geography of the asset zone; and plural icons, displayed over the map overlay, respectively corresponding to positions of the assets in the asset zone, wherein the one or more characteristics of the assets are displayed in respective association with the icons; and wherein the selectable options comprise one or more user selectable common characteristics of the assets, the controller being operable to control display of the icons based in part on the selectable common characteristics, such that when the user selects one of the selectable common characteristics by way of the user interface, the controller is operable to control display of one or more of the icons, corresponding to one or more of the assets that exhibit said one of the selectable common characteristics that is selected by the user, to a common icon display format; and wherein the assets comprise vehicles.

7. The system of claim 1, further comprising:
a user computer configured to communicate with the controller, wherein the user computer comprises the user interface,
wherein the user computer and the controller are operable to control display of, as the one or more characteristics of the assets, respective statuses and locations of the assets within the asset zone, and
wherein the user computer is further operable, in conjunction with the controller, to provide the selectable options to the user for managing the assets within the asset zone.

8. The system of claim 7, wherein the user computer comprises a wireless, mobile, hand-held device configured to interact with the assets by reading identifier devices coupled to the assets.

9. The system of claim 7, wherein the user computer comprises a stationary device configured to interact with the assets traveling proximate to the stationary device by reading identifier devices coupled to the assets.

10. The system of claim 7, wherein the displayed representation of the statuses and locations of the assets correspond to one or more of an asset identification code, a loaded commodity type, an asset destination, an asset origin, a container type, an asset health, an equipment status, an asset maintenance status, an asset loaded/empty status, an asset ownership, or asset geographic coordinates.

11. The system of claim 7, wherein the displayed representation of the assets includes one or more of graphical icons or text information.

12. A computerized method comprising:
obtaining transportation information associated with assets associated with an asset zone;
based at least in part on the transportation information that is obtained, controlling display of representations of the assets located within the asset zone along with characteristics of the assets; and
providing selectable options to a user for reviewing and editing the transportation information.

13. The method of claim 12, further comprising displaying the representations as one or more of graphical icons or text information.

14. The method of claim 12, wherein the characteristics include one or more of asset container type, asset identification, asset status, asset commodity type, customer identity an asset commodity, weight information, way billing information, or asset ownership.

15. The method of claim 12, further comprising checking a status of one of the assets, wherein checking the status includes one or more of checking what type of commodity is loaded on said one of the assets, checking an identity of a customer of a commodity loaded on said one of the assets, checking an assigned destination of said one of the assets, checking an origin of said one of the assets, checking an owner of said one of the assets, checking a current health of said one of the assets, or checking a maintenance history of said one of the assets.

16. The method of claim 12, wherein the transportation information is obtained from a transportation management system.

17. The method of claim 12, wherein the transportation information includes waybill information.

18. A system comprising:
a controller,
wherein the controller is operable to control display of, on a display screen, a representation of an asset zone and representations of assets located within the asset zone, and
wherein the controller is operable to control, based on user input, modification of the representation of the asset zone that is displayed on the display screen, modification of characteristics of the representations of the assets that are displayed on the display screen, and movement of the representations of the assets that are displayed on the display screen.

19. The system of claim 18, wherein the representations and movements correspond to asset zones and assets, and the actual characteristics and movements of those assets in the real world.

20. The system of claim 18, wherein the modification of a representation of an asset zone includes adding or deleting representations of tracks within the representation of the asset zone.

21. The system of claim 18, wherein the modification of characteristics of representations of assets includes color coding the representations of the assets.

22. The system of claim 18, wherein the modification of characteristics of representations of assets includes assigning characteristics to the representations of the assets.
